(19) United States
(12) Patent Application Publication
(10) Pub. No.: US 2007/0286600 A1
(43) Pub. Date: Dec. 13, 2007

(54) Universal IR Repeating over Optical Fiber

(75) Inventors: Yong Guo, Irvine, CA (US); Mingcheng Xu, Simi Valley, CA (US); Shing-Wu P. Tzeng, Fountain Valley, CA (US)

Correspondence Address: FENWICK & WEST LLP, SILICON VALLEY CENTER, 801 CALIFORNIA STREET, MOUNTAIN VIEW, CA, 94041, US

(73) Assignee: OWLINK TECHNOLOGY, INC., Irvine, CA (US)

(21) Appl. No.: 11/747,071

(22) Filed: May 10, 2007

Related U.S. Application Data
(63) Continuation-in-part of application No. 11/423,381, filed on Jun. 9, 2006.

(51) Int. Cl. H04J 14/00; H04B 10/00

(52) U.S. Cl. 398/43; 398/107; 398/113

(57) ABSTRACT

Infrared control signals are repeated and communicated in a system including a source device and a sink device that are communicatively coupled by a serial communication link that includes a forward channel and a backward channel. Modulated infrared remote control data is detected by an infrared detector without de-modulation, and sampled in modulated form. Sampled data corresponding to the modulated remote control signal is transmitted from the sink device to the source device over the serial communication link, which in one example is a single optical fiber. The source device receives the sampled data and regenerates the infrared control data, which is then used to control the operation of the source device.

### CROSS-REFERENCE TO RELATED APPLICATIONS

This application is a continuation-in-part application of, and claims priority under 35 U.S.C. § 120 from, U.S. patent application Ser. No. 11/423,381 filed on Jun. 9, 2006, entitled “Integrated Remote Control Signaling,” which is incorporated by reference herein in its entirety.

This application is also related to (i) U.S. patent application Ser. No. 11/406,558 filed on Apr. 18, 2006, entitled “Protocol for Uncompressed Multimedia Data Transmission,” to (ii) U.S. patent application Ser. No. 11/406,875, filed on Apr. 18, 2006, entitled “EDID Pass Through via Serial Channel,” to (iii) U.S. patent application Ser. No. 11/173,409, filed on Jun. 30, 2005, entitled “Bidirectional HDCP Transmission Module Using Single Optical Fiber,” to (iv) U.S. patent application Ser. No. 11/142,882, filed on May 31, 2005, entitled “High Speed Free Space Optical Detection with Grating Assisted Waveguide,” and to (v) U.S. patent application Ser. No. 10/864,755, filed on Jun. 8, 2004, entitled “Scheme For Transmitting Video and Audio Data of Variable Formats Over a Serial Link of a Fixed Data Rate,” all of which are incorporated by reference herein in their entirety.

### BACKGROUND OF THE INVENTION

1. Field of the Invention

The invention relates to controlling electronic devices using a remote control device.

2. Description of the Related Art

Infrared (IR) remote controllers are widely used to control consumer appliances such as televisions, DVD players, satellite/cable setup boxes, etc. A remote control enables the consumer to control a target device remotely. However, remote controls are associated with problems, particularly when there are multiple pieces of equipment to be controlled and at least one piece is not in the user's forward field of view.

Consider, for example, a home entertainment system or media center application that includes a digital television (DTV) and a DVD player that is equipped with a remote control. Normally, the user simply points the remote control at the DVD player to control its functionality (e.g., play, pause, stop, etc). However, if the DTV is located in front of the user, and the DVD player is located behind the user (e.g., in the rack of a media center), then using the remote control becomes somewhat more involved.

In particular, the user has to point the remote control backward to the DVD player location. This is awkward in that the user has to divide his attention (at least to some extent) to both the DTV in front of him and the DVD player behind him. Moreover, many users intuitively point the remote control at the DTV in effort to control the DVD player. Unfortunately, aiming the remote control at the DTV will not control the DVD player behind the user, as the remote control operates on a line-of-sight basis and needs to be pointed at least in the general direction of the device of which it is intended to control.

One solution is to install an IR repeater circuit, which includes an IR receiver and an IR emitter. Typically, the IR receiver is installed proximate the TV in the user's field of view, and the IR emitter is installed in a location within sight of the device to be controlled (e.g., DVD player or VCR). A pair of copper wires connects the IR receiver to the IR emitter. However, such IR repeater require dedicated circuitry and wiring therebetween, in addition to the components and cabling between the sink and source devices. Additional circuitry and wiring add to undesirable clutter in the user's space.

Thus, there is a need for better remote control techniques.

### SUMMARY OF THE INVENTION

An embodiment of the present invention provides a method for repeating infrared control signals in a system including a source device (e.g., DVD player) and a sink device (e.g., digital television) communicatively coupled by a serial communication link that includes forward and backward channels. Infrared remote control data is detected by an infrared detector without de-modulation, and sampled in a programmable sampling period. Sampled data corresponding to the modulated remote control signal is transmitted from the sink device to the source device over the serial communication link, which in one example is an optical fiber. The source device receives the sampled data and regenerates the infrared control data, which is used to control the operation of the source device.

By utilizing two-way communication, an IR remote control signal can be securely duplicated on the source-side when the user provides the remote control signal to the sink-side. The IR repeating is “universal” because it does not require knowledge of the modulation frequency of the IR signal. The IR repeating scheme in this disclosure will work with any modulation frequency, because the modulation frequency is embedded in the sampled IR control signal itself that is transmitted from the sink device to the source device over the ASMI link. The integrated solution makes controlling a video source device easy for a user, in that the user can intuitively point the IR remote control at the video sink device to control a source device that is not in the consumer's forward field of view. No separate cabling (other than the optical fiber) for carrying the remote control signals is needed. Rather, the remote control signaling data is carried, for example, in the same optical fiber as the payload data (e.g., video and/or audio), or via a wireless transmission (e.g., RF or optical). In either such cases, a forward channel can simultaneously carry payload data from the source device to the sink device.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 illustrates a remote controlled multimedia data communication system, configured in accordance with an embodiment of the present invention.

FIG. 2A illustrates an asymmetrical serial multimedia interface (ASMI) for the source device of FIG. 1, configured in accordance with an embodiment of the present invention.

FIG. 2B illustrates an ASMI for the sink device of FIG. 1, configured in accordance with an embodiment of the present invention.

FIG. 2C illustrates a conventional IR detector and its input and output waveforms.

FIG. 2D illustrates the IR detector shown in FIG. 2B and its input and output waveforms, configured in accordance with an embodiment of the present invention.

FIG. 3A illustrates a remote controlled multimedia data communication system configured in a point-to-point connection scheme, configured in accordance with an embodiment of the present invention.

FIG. 3B illustrates a remote controlled multimedia data communication system configured in a daisy-chain connection scheme, configured in accordance with an embodiment of the present invention.

FIG. 3C illustrates a remote controlled multimedia data communication system configured with a media center, configured in accordance with an embodiment of the present invention.

FIG. 4A illustrates a multimedia data communication system configured for integrated remote control signaling, configured in accordance with an embodiment of the present invention.

FIGS. 4B, 4C, and 4D illustrate an integrated remote control signaling scheme configured in accordance with an embodiment of the present invention.

FIG. 5 illustrates how an example IR remote control signal is characterized as an electrical signal, configured in accordance with an embodiment of the present invention.

### DETAILED DESCRIPTION OF THE INVENTION

A serial transmission protocol and architecture are provided that can be used to forward the raw remote control data in modulated form, between sink (e.g., DTV) and source (e.g., DVD) devices, in addition to other data such as video/audio/control data. The target device need not be in the line of sight of the remote control beam. Daisy-chained devices will pass the remote control signal to the appropriate target device, so that the user can point any remote control at the DTV or other conveniently located device in the system, and still control the actual target device.

General Overview

One embodiment of the present invention is a protocol that enables a very high bandwidth (e.g., 1.5 Gbps (gigabits per second) or higher) in one direction for payload data such as video/audio. The transmission path in this direction is called a forward channel. The protocol also enables a relatively low speed communication link in the opposite direction for carrying processing control data, as well as remote control data. This path is called a backward channel. The protocol can be configured to support all the available formats, and is very flexible, so that adoption of new formats is facilitated. Control and timing signals can also be carried by the forward channel from the source device to the sink device for correct video/audio signal regeneration.

The protocol is herein referred to as the Asymmetrical Serial Multimedia Interface (ASMI) protocol, since it has a high bandwidth requirement in one direction and a low bandwidth requirement in the other. The protocol can be transmitted, for example, via a digital optical fiber link, digital optical wireless link, or a radio frequency (RF) link. Similarly, a combination of such links can be used, such as a high speed optical wireless link for the forward channel and a relatively slower speed RF link for the backward channel. In another particular embodiment, a single optical fiber is used to implement both the forward and backward channels.

The protocol can be used in conjunction with a number of system configurations. In one particular embodiment, a multimedia system configured with a daisy-chain topology is enabled. The system is capable of transmitting uncompressed multimedia data, and includes multiple sources and/or sink devices. The multimedia system can be configured with an automatic and dynamic addressing assignment scheme that allows a user to rewire source and/or sink device cables, wherein all addressing for all networked devices automatically updates to maintain reliable communication. Other system configurations, such as point-to-point and media center configurations, can also be implemented with the protocol.

System Architecture

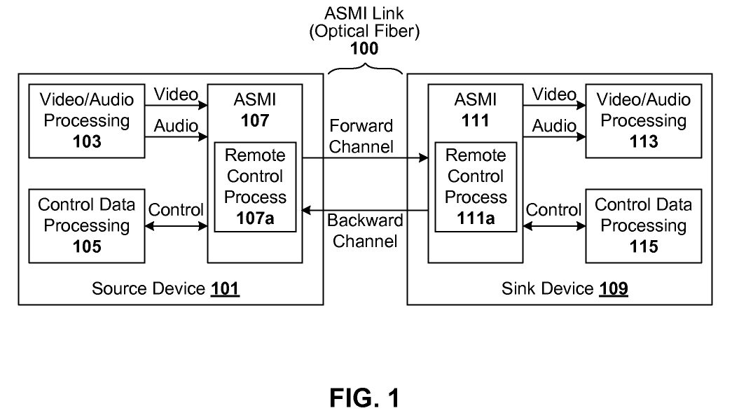

FIG. 1 is a block diagram of a remote controlled multimedia data communication system, configured in accordance with an embodiment of the present invention.

As can be seen, the system includes a source device 101 and a sink device 109 communicatively coupled via an asymmetric serial multimedia interface (ASMI) link 100. The source device 101 can be, for example, a DVD player, satellite/cable receiver box or set-top box, computer, or other suitable multimedia source. The source device 101 generates multimedia data and sends it via the ASMI link 100, which in this example is an optical fiber. The sink device 109 can be, for example, a digital television, monitor, projector or other suitable display device. The sink device 109 receives multimedia data via the ASMI link 100 and displays that data.

In the example embodiment shown in FIG. 1, the source device 101 includes an ASMI section 107 configured with a remote control process 107a, a video/audio processing section 103, and a control data processing section 105. The video/audio processing section 103 can be in the same device as the ASMI section 107 (as shown in FIG. 1). In alternative embodiments, the video/audio processing section 103 can be in a separate device that is operatively connected to the source device 101 via a standard DVI/HDMI cable (or other suitable interconnect). Likewise, the control data processing section 105 can be in the same device as the ASMI section 107 (as shown in FIG. 1). In alternative embodiments, the control data processing section 105 can be in a separate device that is operatively coupled with the source device 101. In general, any of the functionality described with reference to device 109 can be integrated into one or more modules/components, and the present invention is not intended to be limited to any one configuration.

Likewise, the sink device 109 includes an ASMI section 111 configured with a remote control process 11a, a video/audio processing section 113, and a control data processing section 115. The video/audio processing section 113 can be in the same device as the ASMI section 111 (as shown in FIG. 1). In alternative embodiments, the video/audio processing section 113 can be in a separate device that is operatively connected to the sink device 109 via a standard DVI/HDMI cable (or other suitable interconnect). Likewise, the control data processing section 115 can be in the same device as the ASMI section 111 (as shown in FIG. 1). In alternative embodiments, the control data processing section 115 can be in a separate device that is operatively coupled with the sink device 109. In general, any of the functionality described with reference to device 109 can be integrated into one or more modules/components.

In operation, the video/audio processing section 103, which can be implemented with conventional technology (e.g., such as that included in a DVD player, satellite/cable receiver box or set-top box, or computer) generates multimedia data (e.g., audio and video), and provides that data to the ASMI section 107. In addition, the control data processing section 105, which can be implemented with conventional technology (e.g., such as that included in a DVD player, satellite/cable receiver box or set-top box, or computer) generates control data, and provides that data to the ASMI section 107. The control data processing section 105 may be further configured to provide additional control functions in accordance with an embodiment of the present invention, as will be apparent in light of this disclosure. These additional control functions (such as those performed by the remote control process 107a) can be implemented within the control data processing section 105, or in a separate control processor module that supplements conventional control functions (as shown in FIG. 1, where the remote control process 107a performs functions that supplement the conventional control functions). The multimedia and control data is multiplexed into a serial stream by the ASMI section 107, and then transmitted to the ASMI section 111 (of the sink device 109) via the forward channel of the ASMI link 100.

The ASMI section 111 demultiplexes the received serial stream back into its multimedia (video and audio) and control data components. The video and audio data are provided to the video/audio processing section 113, which can be implemented with conventional technology (e.g., such as that included in a digital TV, monitor, or projector). The video/audio processing section 113 processes that multimedia data so that it can be displayed/sounded to the user. In addition, the received control data is provided to the control data processing section 115, which can be implemented with conventional technology (e.g., such as that included in a digital television, monitor, projector or other suitable display device). The control data processing section 115 may be further configured in accordance to provide additional control functions in accordance with an embodiment of the present invention, as will be apparent in light of this disclosure. These additional control functions (such as those performed by the remote control process 111a) can be implemented within the control data processing section 115 of the sink device 109, or in a separate control processor module that supplements conventional control functions (as shown in FIG. 1, where the remote control process 11a performs functions that supplement the conventional control functions). The control data supports and otherwise enables, for example, the processing of the multimedia data into the original video/audio, the processing of remote control and other user control functions, and the processing of other data applications, as will be explained in turn.

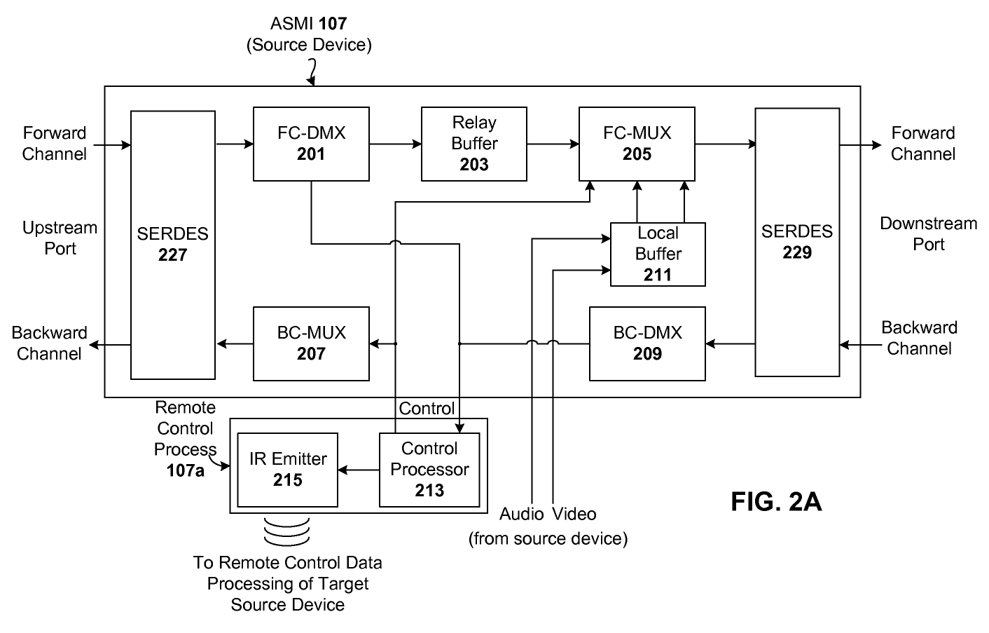

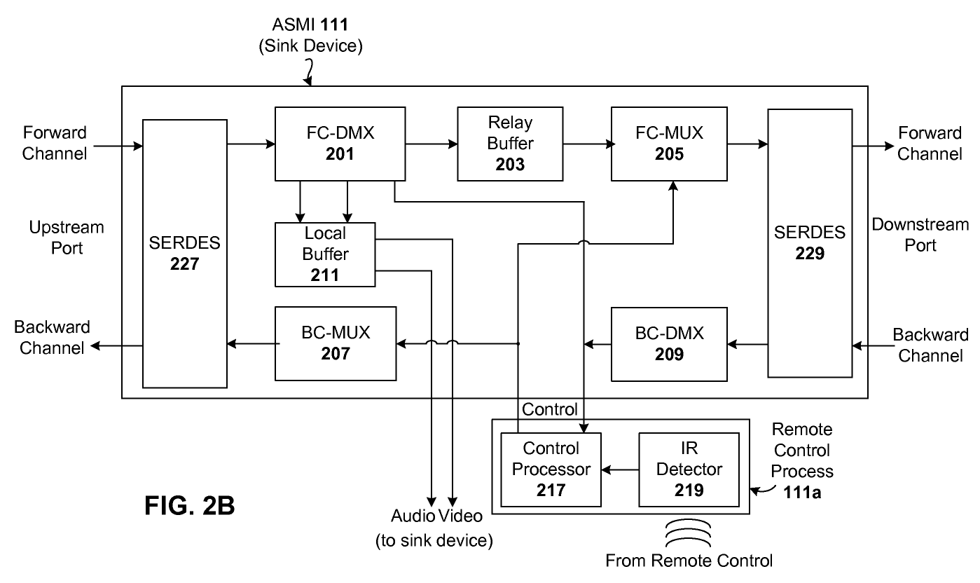

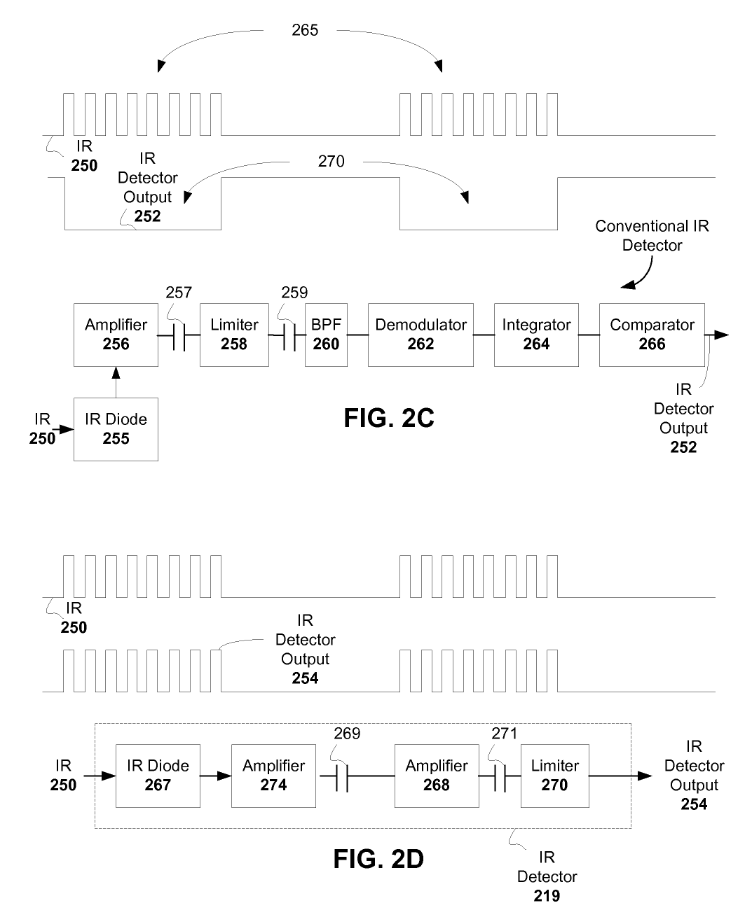

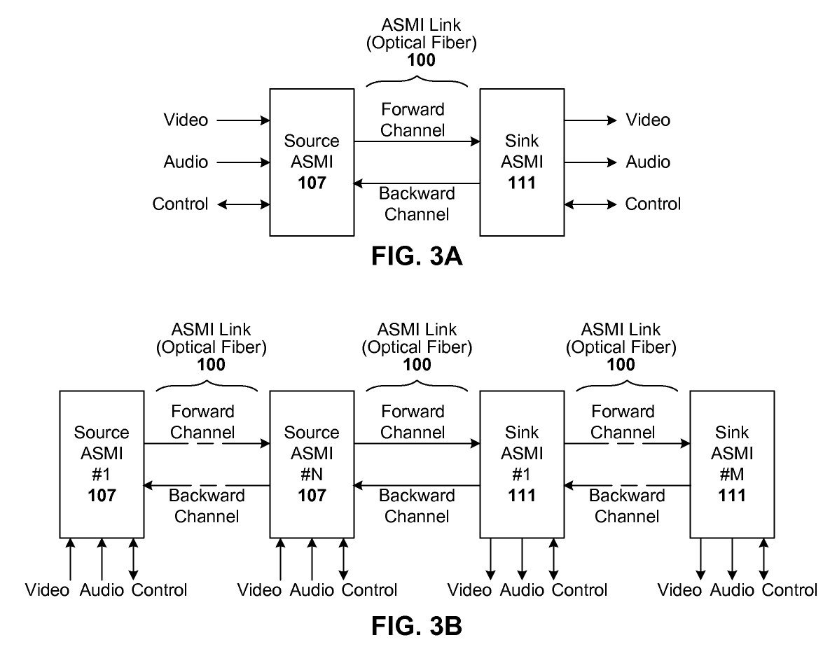

Control data, including remote control data, can also be provided from the sink device 109 to the source device via the backward channel. In particular, control data processing section 115 provides control data to the ASMI section 111, which multiplexes that control data for transmission to the ASMI section 107 (of the source device 101). In addition, the remote control process 111a operates to detect incoming IR remote control data and convert it into electrical signals that can also be multiplexed for transmission to the ASMI section 107. Again, note that remote control process 111a can be integrated into the control data processing 115 (or some other dedicated module) if so desired. In any case, ASMI section 107 then receives and demultiplexes the control data transmitted by the ASMI 111 using the backward channel of the ASMI link 100. That control data is then provided to the control data processing section 105. In addition, the remote control data included in the received control data is regenerated by the remote control process 107a (so that it can be used to control the local source device 101). The ASMI section 107 will be discussed in more detail with reference to FIG. 2a, and the ASMI section 111 will be discussed in more detail with reference to FIG. 2b.

The ASMI link 100 can be implemented using conventional or custom technology (e.g., optical, RF, or combination), and can be wired or wireless or a combination of the two if so desired. In one particular embodiment, the forward and backward channels of the ASMI link 100 are implemented using a pair of optical transceivers communicatively coupled by a single fiber as described in the U.S. patent application Ser. No. 11/173,409. This application Ser. No. 11/173,409, filed on Jun. 30, 2005 and titled, “Bidirectional HDCP Transmission Module Using Single Optical Fiber,” is herein incorporated in its entirety by reference. In such an embodiment, the ASMI section 107 could include or otherwise be coupled with a transceiver module (e.g., VCSEL and photodetector) for implementing the forward channel transmitter and the backward channel receiver. Also, the ASMI section 111 could include or otherwise be coupled with a transceiver module (e.g., LED and PIN detector) for implementing the backward channel transmitter and the forward channel receiver. Numerous wired optical transceiver configurations can be used to effect communication between the devices 101 and 109.

In another particular embodiment, the forward and backward channels of the ASMI link 100 are implemented using an optical wireless communication channel as described in the U.S. patent application Ser. No. 11/142,882. This application Ser. No. 11/142,882, filed on May 31, 2005 and titled, “High Speed Free Space Optical Detection with Grating Assisted Waveguide,” is herein incorporated in its entirety by reference. In such an embodiment, the ASMI section 107 could include or otherwise be coupled with a transceiver module (e.g., transmitter with grating assisted receiver) for implementing the forward channel transmitter and the backward channel receiver. Also, the ASMI section 111 could include or otherwise be coupled with a transceiver module (e.g., transmitter with grating assisted receiver) for implementing the backward channel transmitter and the forward channel receiver. In such a case, the ASMI link 100 is actually a forward communication link and a backward communication link. Numerous wireless optical transceiver configurations can be used to effect communication between the devices 101 and 109.

In another such embodiment, the forward channel can be implemented using any wireless optical link (such as a VCSEL and PIN detector), and the backward channel can be implemented with a relatively slower RF link (e.g., such as an IEEE 802.11 or other such RF wireless communication link).

ASMI for Source Device

FIG. 2A is a block diagram of an ASMI 107 for the source device of FIG. 1, configured in accordance with an embodiment of the present invention. As previously explained, ASMI 107 can exist independently of the source device in other embodiments, if so desired. In addition, note that in this embodiment, the remote control process 107a is implemented externally to the ASMI 107 (as opposed to being integrated as shown in FIG. 1). Numerous such configurations and variations will be apparent in light of this disclosure.

This example ASMI 107 has a downstream port and an optional upstream port. The downstream port includes a high speed forward channel transmission port and a low speed backward channel receiving port. The optional upstream port, which includes a low speed backward channel transmission port and a high speed forward channel receiving port, can receive video/audio signals from an upstream source device in a daisy-chain configuration, as will be discussed in turn.

In operation, the ASMI 107 receives video and audio data from a local video/audio source device (e.g., video/audio processing section 103, such as that included in a DVD player or other such source). The video and audio data is saved into an elastic buffer referred to in FIG. 2a as local buffer 211. The ASMI 107 has a forward channel multiplexer (FC-MUX) 205 that multiplexes the buffered video/audio data for transmission via the downstream high speed forward channel.

If there is an upstream port, the forward channel demultiplexer (FC-DMX) 201 sends received control data, including any remote control data, to a local control processor 213 included in the remote control process 107a. Recall that processor 213 can be included in the ASMI 107 architecture, or otherwise communicatively coupled with the ASMI 107 (as shown in FIG. 2a). Alternatively, processor 213 can be implemented within the control data processing section 105, if so desired. The FC-DMX 201 also temporarily buffers received video/audio data in an elastic buffer referred to in FIG. 2a as relay buffer 203. The FC-MUX 205 also multiplexes the video/audio data from that relay buffer 203 for transmission via the downstream high speed forward channel. The two elastic buffers 203 and 211 (e.g., FIFO buffers) are used to buffer respective stream data while the other stream is being transmitted.

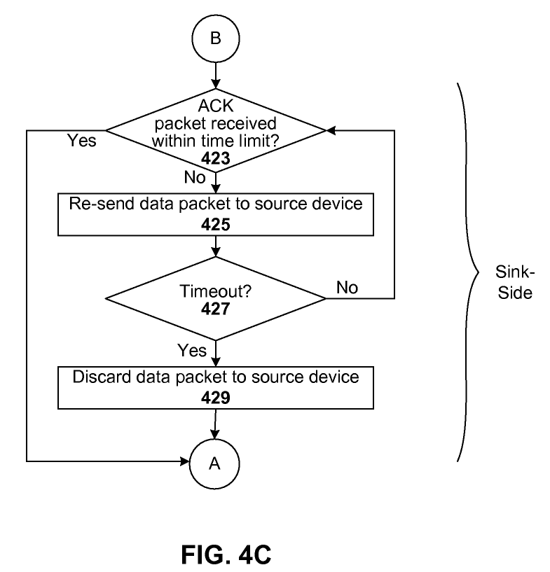

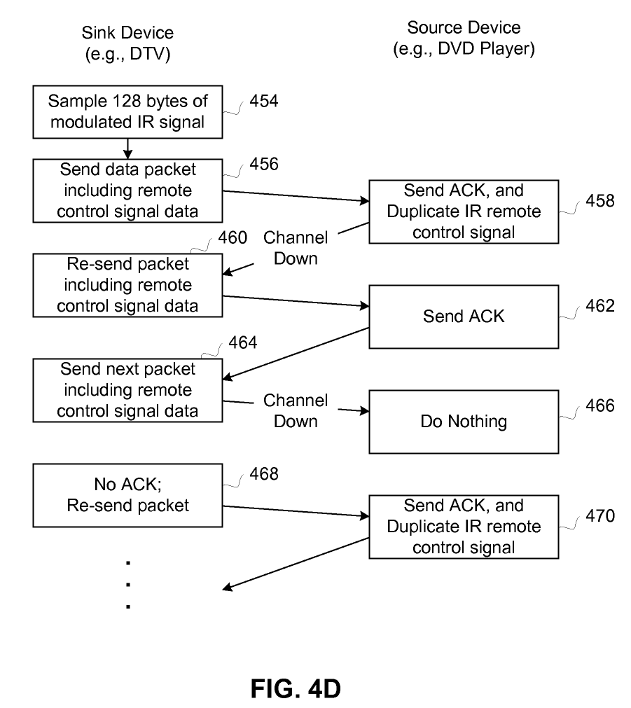

The ASMI 107 also has a backward channel demultiplexer (BC-DMX) 209 that demultiplexes control data (including any remote control data) received via the downstream backward channel, so that control data can then be provided to the local control processor 213. The control data from the upstream high speed forward channel (extracted by the FC-DMX 201) and from the downstream low speed backward channel (extracted by the BC-DMX 209) are sent to the local control processor 213 for processing. Any remote control data destined for the local device is converted back into its IR form by operation of the control processor 213 and IR emitter 215. The control processor 213 also transmits the control data to the downstream device via the FC_MUX 205, and to the upstream device (if there is one) via a backward channel multiplexer (BC-MUX) 207, which multiplexes the control data for transmission via the upstream backward channel. The remote control process 107a (including IR emitter 215 and control processor 213) is discussed in more detail with reference to FIGS. 4A-4D.

Communication between the local control processor 213 (and/or the control data processing section 105) and the ASMI 107 can be carried out using custom or conventional technology, such as USB, Ethernet, or universal asynchronous receiver transmitter (UART).

A SERDES (Serializer/Deserializer) block 227 is coupled between the upstream port and the FC-DMX 201 and the BC-MUX 207. Also, SERDES block 229 is coupled between the downstream port and the FC-MUX 205 and the BC-DMX 209. The SERDES blocks 227, 229 are transceiver blocks that convert parallel data to serial data for communication on the ASMI link 100 in serial format, and vice versa. The transmitter section of the SERDES is a serial-to-parallel converter, and the receiver section is a parallel-to-serial converter. Although the SERDES block 227 is shown to be separate from the FC-DMX 201 and BC-MUX 207 in FIG. 2A, the FC-DMX 201 and BC-MUX 207 can be included and form part of the SERDES block 227. Also, although the SERDES block 229 is shown to be separate from the FC-MUX 205 and BC-DMX 209 in FIG. 2A, the FC-MUX 205 and the BC-DMX 209 can be included in, and form part, of the SERDES block 229.

ASMI for Sink Device

FIG. 2B is a block diagram of an ASMI 111 for the sink device of FIG. 1, configured in accordance with an embodiment of the present invention. As previously explained, ASMI 111 can exist independently of the sink device in other embodiments, if so desired.

This example ASMI 111 has an upstream port and an optional downstream port. The upstream port includes a high speed forward channel receiving port and a low speed backward channel transmission port. The optional downstream port, which includes a low speed backward channel receiving port and a high speed forward channel transmission port, can provide video/audio signals to a downstream sink device in a daisy-chain configuration, as will be discussed below.

In operation, the ASMI 111 receives video, audio, and control data from the high speed forward channel receiving port. The FC-DMX 201 sends received control data to a local control processor 217. Recall that processor 217 can be included in the ASMI 111 architecture, or otherwise communicatively coupled with the ASMI 111 (as shown in FIG. 2b). Alternatively, processor 217 can be implemented within the control data processing section 115, if so desired. The video and audio data is saved into the local buffer 211, in preparation for display (e.g., by operation of video/audio processing section 113, such as that included in a digital TV or other such sink device). If the received video and audio data is not destined for the local display device, the FC-DMX 201 writes that data into the relay buffer 203. The FC-MUX 205 multiplexes the video/audio data from that relay buffer 203 for transmission via the downstream high speed forward channel. The two elastic buffers 203 and 211 (e.g., FIFO buffers) are used to buffer respective stream data while the other stream is being transmitted.

The control data from the upstream high speed forward channel (extracted by the FC-DMX 201) and from the downstream low speed backward channel (extracted by the BC-DMX 209) are sent to the local control processor 217 for processing. The control processor 217 also transmits the control data to the downstream device (if there is one) via the FC-MUX 205, and to the upstream device via a BC-MUX 207, which multiplexes the control data for transmission via the upstream backward channel. In addition, IR detector 219 is adapted to receive incoming IR remote control signals (provided by a user pointing a remote control at the local sink device), and to convert those IR signals into electrical signals. The control processor 217 then transmits that remote control data (in electrical signal form) to the downstream device (if there is one) via the FC-MUX 205, and to the upstream device via a BC-MUX 207, which multiplexes the control data for transmission via the upstream backward channel. Note that the processing of control information can be implemented the same way as that of source device. The remote control process 111a (including IR detector 219 and control processor 217) is discussed in more detail with reference to FIGS. 4A-4D.

Communication between the local control processor 217 (and/or the control data processing section 115) and the ASMI 111 can be carried out using custom or conventional technology, such as USB, Ethernet, universal asynchronous receiver transmitter (UART), or the like.

Each of FC-MUX 205 and BC-MUX 207 can be programmed or otherwise configured to provide simple multiplexing. Likewise, each of FC-DMX 201 and BC-DMX 209 can be programmed or otherwise configured to provide complementary demultiplexing. In one particular embodiment, the multiplexers (FC-MUX 205 and BC-MUX 207) are implemented as a multiplex state machine, and the demultiplexers (FC-DMX 201 and BC-DMX 209) are implemented as a demultiplex state machine. Each of these MUX/DMX state machines will be discussed in turn. Other techniques for serializing data for transmission, and then deserializing that data for receiver processing can be used here, as will be apparent in light of this disclosure.

SERDES (Serializer/Deserializer) block 227 is coupled between the upstream port and the FC-DMX 201 and the BC-MUX 207. Also, SERDES block 229 is coupled between the downstream port and the FC-MUX 205 and the BC-DMX 209. The SERDES blocks 227, 229 are transceiver blocks that convert parallel data to serial data for communication on the ASMI link 100 in serial format, and vice versa. The transmitter section of the SERDES is a serial-to-parallel converter, and the receiver section is a parallel-to-serial converter. Although the SERDES block 227 is shown to be separate from the FC-DMX 201 and BC-MUX 207 in FIG. 2B, the FC-DMX 201 and BC-MUX 207 can be included and form part of the SERDES block 227. Also, although the SERDES block 229 is shown to be separate from the FC-MUX 205 and BC-DMX 209 in FIG. 2B, the FC-MUX 205 and the BC-DMX 209 can be included in, and form part, of the SERDES block 229.

Automatic/Dynamic Addressing Assignment

As previously discussed, the multimedia system can be configured with an automatic and dynamic addressing assignment scheme that allows a user to rewire source and/or sink device cables, wherein all addressing for all networked devices automatically updates to maintain reliable communication. In more detail, each source and sink device is assigned with an address. This will allow control information (including remote control data) to be passed among all source devices and sink devices.

The address assignment mechanism in accordance with one embodiment of the present invention is designed to satisfy the following requirements: (1) the assignment is fully automatic, so no switch and other user interface is needed; (2) the assignment is dynamic, such that the address is updated to reflect any network cabling change by the user; and (3) the address and its assignment scheme are transparent to the user. The address is based on the position and ordering of each device in the daisy-chain connection.

In one particular embodiment, the address assignment mechanism is implemented using the forward channel data format. In particular, the forward channel format includes a field (e.g., one byte) called upstream device address. In one such case, the address has the following 8 bit format:

| Bit 7 | Bit 6 | Bit 5:0 |
|---|---|---|
| Source Bit | Sink Bit | Position |

Source Bit: 1: The device has video/audio source
   0: The device does not have video/audio source
Sink Bit: 1: The device can display video/audio
   0: The device can not display video/audio
Position: This six bit address is derived from the device position in the daisy chain. If there is no upstream port detected, the address shall be assigned as one. For any one downstream device in the chain, if the upstream device has an position portion of the address of i, then that one position portion of the downstream device address shall be assigned as i+1.

This upstream device address field makes it possible for the downstream device to update its address whenever the user changes the cable configuration. For example, if the upstream port address received by a downstream device has changed (e.g., because the user has added a new piece of equipment, such as a second DVD player), then the local address assignment for that downstream device is updated so that its address is one plus the address of the received upstream port address. Detecting a change in upstream port address can be carried out, for example, by the local control processor 213 or 217 (or other local computing function). The control processor 213 or 217 can then compute the new address for the device.

FIG. 2C illustrates a conventional IR detector and its input and output waveforms. The conventional IR detector includes an IR detector diode 255, an amplifier 256, a limiter 258, a band pass filter 260, a demodulator 262, an integrator 264, and a comparator 266, and decoupling capacitors 257, 259. The IR input signal 250 received by the IR detector diode 255 is amplified by the amplifier 256, input to the decoupling capacitor 257, and limited by the limiter 258. The limiter 258 operates as an automatic gain controller (AGC) circuit to obtain a constant amplitude level regardless of the distance of the IR detector to the IR transmitter (not shown) of a remote controller (not shown). After passing the limited IR signal through the decoupling capacitor 259, the IR signal passes through the band pass filter 260 tuned to the modulation frequency of the IR transmitter. Typical IR transmitters use 38 KHz as the modulation frequency, although there are IR transmitters that use different modulation frequencies. Then, the demodulator 262, the integrator 264, and the comparator 266 operate to detect the presence of the modulation frequency in the input IR signal 250. If the modulation frequency is present 265 in the input IR signal 250, the level of the IR detector output signal 252 is pulled low 270, as shown in FIG. 2C. In other words, the output 252 of the IR detector is high where the IR signal 250 is not modulated. The modulated parts 265 of the IR signal 250 occur when a user activates the remote controller (not shown) and in response the IR transmitter of the remote controller sends out a sequence of high and low modulated pulses 265.

With the type of conventional IR detector in FIG. 2C, data corresponding to the IR detector output 252 is sent from the sink device to the source device 101 over the ASMI link. Information on the modulation frequency is lost in the detection process of the conventional IR detector of FIG. 2C and thus not transmitted to the source device 101. In most cases, the IR signal 250 can still be regenerated at the source device 101 (by the control processor 213) by assuming that the modulation frequency is a typical one, 38 KHz. However, if the modulation frequency used in the input IR signal 250 by the IR transmitter is not a typical one, the source device 101 cannot properly regenerate the IR signal 250 because the source device 101 would not have information on the actual modulation frequency of the IR signal 250. Thus, the conventional IR detector in FIG. 2C has the disadvantage that the input IR signal 250 cannot be replicated at the source device 101 unless the IR signal 250 is modulated with a known, agreed-upon modulation frequency.

FIG. 2D illustrates the IR detector 219 shown in FIG. 2B and its input and output waveforms. The IR detector 219 includes an IR detector diode 267, amplifiers 274, 268, decoupling capacitors 269, 271, and a limiter 270. The IR input signal 250 received by the IR detector diode 267 is amplified by the amplifiers 274, 268 (passing through the decoupling capacitors 269, 271), and limited by the limiter 270. The limiter 270 operates as an automatic gain controller (AGC) circuit to obtain a constant amplitude level regardless of the distance of the IR detector 219 to the IR transmitter (not shown) of a remote controller (not shown). After passing through the limiter 270, note that the IR signal does pass through any demodulation circuitry. Thus, the output 254 of the IR detector 219 has a modulated shape identical to the shape of the input IR signal 250 (i.e., not de-modulated). The IR detector output 254 is sampled by the control processor 217. In one embodiment, the IR detector output 254 (which has high and low states) is connected to the control processor 217 if the voltage range of the IR detector output 254 falls under an input voltage range of the control processor 217. In this manner, the IR detector output 254 can be sampled directly without utilizing analog-to-digital converters (ADCs), which is more expensive to use and needs more time to process. In other embodiments, other conventional sampling techniques such as ADCs may be used to sample the IR detector output 254.

As shown in FIG. 2D, By virtue of the sampling by the control processor 217, the control processor 217 would output an electrical signal represented by a digital “1” when the IR signal 250 is high and digital “0” when the IR signal 250 is low. Each sample of the received IR signal is represented by a binary bit. Since the carrier frequency of the IR signal 250 can be, for example, up to 110 KHz, a fast sampling rate of the control processor 217 is needed. For example, 2 Mbps (2 million samples per second) rate is a suitable sampling rate, and 4 Mbps is even better. As will be explained further with reference to FIGS. 4A-4D, the control processor 217 outputs the sampled IR signal with eight samples grouped together as a byte. The ASMI 111 (specifically, the control processor 217) sends a fixed length of bytes (e.g., 128 bytes) to the source device 101 through the upstream port via the BC-MUX 207 and SERDES 227 or to the downstream port device, if any, through the FC-MUX and SERDES 229. Note that if a 4 Mbps sampling rate is used, the backward channel speed of the ASMI link 100 should be at least 16 Mbps to allow for retransmission mechanisms as will be explained below with reference to FIGS. 4A-4D.

Note that the bandwidth of the amplifiers 274, 268 should be at least twice the maximum frequency of the IR signal 250. However, since noise generally increases with electrical bandwidth, the IR detector 219 preferably can have just enough bandwidth to receive the highest desired signal frequency to obtain maximum signal reception sensitivity. Optical remote controls send digital data by amplitude modulation of a digital carrier signal, typically in the range of 20-56 KHz with some newer ones proposing use up to 100 KHz. Thus, in one embodiment, the amplifiers 274, 268 have bandwidths of 200 KHz. The AC coupling capacitors 269, 271 ensure that the amplified offset voltages do not saturate the output voltage of the final stage, and their capacitance values are chosen to ensure that the lowest desired frequency of 20 KHz is transmitted.

With the IR detector 219 in FIG. 2D, electrical data corresponding to the IR detector output 254 is sent from the sink device 109 to the source device 101 over the ASMI link 100, with the electrical data representative of the samples of the IR detector output 254 in modulated form. Therefore, information on the modulation frequency is embedded in the electrical signal itself that is transmitted to the source device 101 over the ASMI link 100. Thus, the source device 101 can regenerate the IR signal 250 regardless of the modulation frequency used, because the source device 101 has the modulation frequency information embedded in the received sampling data corresponding to the modulated IR detector output 254 signal.

In order to regenerate the IR signal 250 based on the samples of the IR detector output 254 received at the source device 101, clock synchronization between the source device 101 and the sink device 109 is needed to prevent IR data packet FIFO over-run or under-run. Clock synchronization is provided by conventional SERDES blocks 227, 229 in the ASMI 107 and ASMI 111. SERDES blocks are typically capable of providing the backward channel speed necessary for the sampling rate while synchronizing the clocks between the source device 101 and the sink device 109. Thus, the sampling by the control processor 217 can be configured to sample the IR signal 250 based on the back channel SERDES 227 clock of the ASMI 111 (sink device) for transmission to the source device 101 over the ASMI link 100, and the IR signal 250 can be regenerated on the source device 101 based on the recovered DESERDES 229 clock of the ASMI 107 (source device). This is possible because SERDES designs typically include clock and data recovery circuits allowing a receiver to extract embedded clock information and re-timed data from an incoming encoded data stream. The extracted DESERDES clock is synchronized with the transmitter clock, making the IR regeneration operate at the same rate as that of the IR transmitters and preventing over-run or under-run problems.

Point-to-Point Configuration

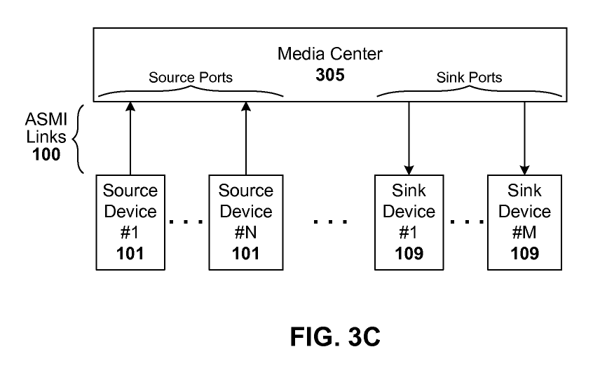

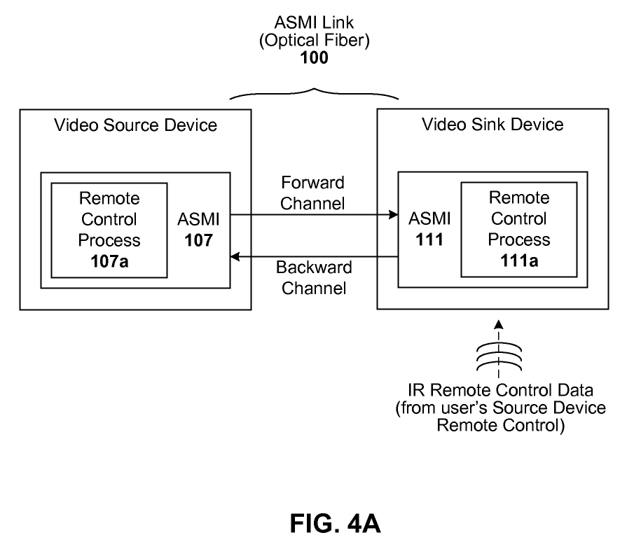

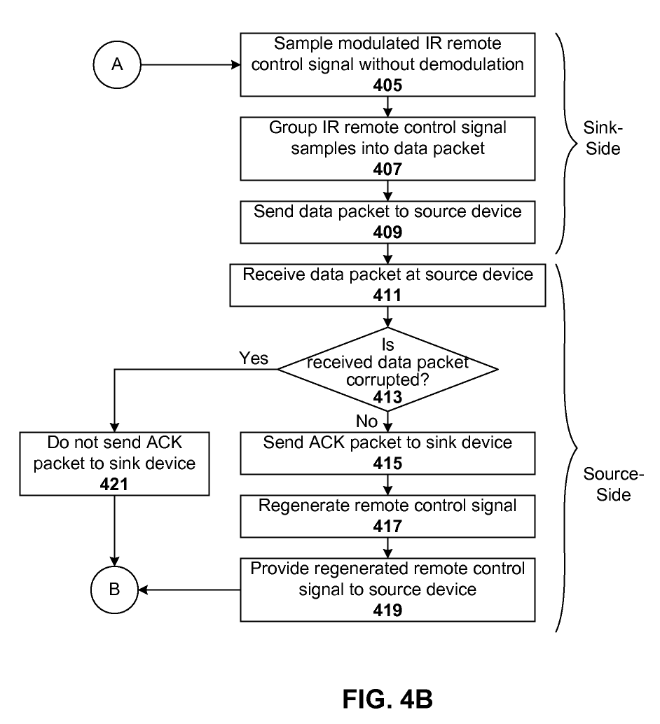

FIG. 3A is a block diagram of a remote controlled multimedia data communication system configured in a point-to-point connection scheme, in accordance with an embodiment of the present invention.

As can be seen, the sink ASMI 111 is connected to the source ASMI 107 via the ASMI link (optical fiber) 100. The ASMI 107 receives multimedia data (video/audio) and control data from a source device (e.g., DVD player that includes video/audio processing section 103 and control data processing section 105 with integrated control processor 213), multiplexes that multimedia data and control data into a serial data stream, and transmits that data stream to the sink ASMI 111 via its downstream port and the ASMI link 100. The sink ASMI 111 receives the serial data stream at its upstream port, and demultiplexes it into separate video/audio streams for display/sounding and control data processing by the sink device (e.g., digital TV that includes video/audio processing section 113 and control data processing section 115 with integrated control processor 217). The previous discussions with reference to FIGS. 1, 2A, 2B, and 2D are equally applicable here. IR remote control data 254 detected, for example, at the sink ASMI 111 can be converted into an electrical signal, and multiplexed onto the backward channel of the ASMI link 100. The IR remote control data 254 is transmitted to the source ASMI 107 over the ASMI link 100 in sampled, modulated form as explained above with reference to FIG. 2D. The ASMI 107 can then demultiplex that remote control signal data, convert it back into its IR form, and provide it to the local source device (e.g., via the control bus), so as to control that source device in accordance with the remote control commands selected by the user. Note that the source device 101 and ASMI 107 need not be in the line of sight of the user and remote control to be so remotely controlled. A similar scheme for remote controlling the sink device 109 by detecting remote control signals (intended for the sink device 109) at the source ASMI 107 can also be used, if so desired.

In this example configuration, external video circuitry is used. However, it will be appreciated in light of this disclosure that the ASMI 107 can be integrated into a source device and ASMI 111 can be integrated into a sink device (as shown in FIG. 1, for example).

Daisy-Chain Configuration

FIG. 3B is a block diagram of a remote controlled multimedia data communication system configured in a daisy-chain connection scheme, in accordance with an embodiment of the present invention. This system configuration allows a user to connect several source devices and/or sink devices to form one network. In this particular embodiment, there are N source ASMIs 107 (for N corresponding source devices) and M sink ASMIs 111 (for M corresponding sink devices), where N is not necessarily equal to M, but can be. Under proper control, each of the M sink devices can display/sound video and/or audio data from each of the N source devices. The source ASMIs 107 and/or sink ASMIs 111 are able to pass high speed multimedia data from the upstream device to the downstream device.

As can be seen, each ASMI 107 and 111 in the daisy-chain receives control data from at least one of two sources: from the upstream device via its high speed forward channel receive port, and from the downstream device via its low speed backward channel receive port. The source ASMI #1 does not have an upstream device, and the sink ASMI #M does not have a downstream device. All the control data received at anyone ASMI is sent to the local processor (e.g., control processor 213/217) for processing, and is not relayed to the downstream device directly. If the control data traffic is not targeted to the local device, the local control processor 213/217 will transmit that traffic to other devices via either the backward channel or the control data field in the forward channel data stream, which will be discussed in turn.

In addition, each ASMI 107 and 111 transmits control data to at least one of two places: to the downstream device via its high speed forward channel transmit port, and to the upstream device via its low speed backward channel transmit port. The addressing and processing of the control data can be carried out, for instance, by the local control processor 213/217 and its associated protocols (which may be proprietary or conventional). The ASMI mechanism described in this example system design passes the control data to and from the local processor, and transmits it via the high speed forward channel and low speed backward channel.

In one embodiment, IR remote control data captured at one of the sink devices and converted into electrical signal data is communicated to one of the source devices in sampled, modulated form, using the backward channel of the ASMI link 100. In a similar fashion, remote control data captured at one of the source devices can be communicated to one of the sink devices using the forward channel of the ASMI link 100 in sampled, modulated form (although this would not be typical, given user propensity to aim the remote control at a sink device such as a DTV, as opposed to a source device, particularly if that source device is out of the user's forward field of view). In any case, the IR remote signal can then be regenerated and provided to control the target device accordingly.

In a multi-source, multi-sink configuration, there is typically more than one multimedia stream. In order to support this operation, a stream number is used. In more detail, and in accordance with one particular embodiment, each multimedia data stream in the forward channel of the ASMI link 100 has a stream number field. The local control processor 213 of each source device programs or otherwise assigns the stream number. The ASMI 107 of the source device transmits its local multimedia data with this assigned stream number in its header, as will be explained in turn. Similarly, the local control processor 217 of each sink device also programs a stream number. Processor 217 sends any received multimedia data stream including a stream number that matches this local stream number to the local device for display/sounding by operation of the ASMI 111. If the stream number does not match, then processor 217 relays the data stream to the downstream device.

The stream number mechanism facilitates user interface for a stream selection process. In particular, and in accordance with an embodiment of the present invention, each source ASMI 107 transmits with its own address as the stream number. In other words, ASMI #1 will transmit multimedia stream number one, and ASMI #2 will transmit multimedia stream number two, and so on. This can be a default stream number assignment scheme if so desired. Each sink ASMI 111 (e.g., in conjunction with its local control processor 217) will detect the total number of active streams and display them to the user (e.g., via a pull down list or other suitable user interface mechanism). The user can then select the desired video stream by selecting one stream from the displayed list. The user selected stream number can be programmed into one or more ASMIs 111, so that each programmed ASMI 111 will know to deliver stream data having that stream number to the local video/audio circuitry. Any number of known user interface techniques and menu schemes can be used to allow the user to access stream information available from the local control processor 217 of the sink device.

In one particular embodiment, for a source ASMI 107, the local data is first stored in the local buffer 211. If there is an upstream port, the data received from that port can be saved in the relay buffer 203. The merge of the local multimedia data and the data from the upstream device can be implemented, for example, with a simple multiplexing (e.g., FC-MUX 205 and BC-MUX 207), as previously explained with reference to FIGS. 2A and 2B. If the relay buffer 203 is not empty, the FC-MUX 205 will first transmit a whole packet from the relay buffer 203. If the relay buffer 203 is empty, the FC-MUX 205 will transmit a data packet from the local buffer 211. The upstream sink device receives transmitted data via its corresponding ASMI 111. The stream number field in the packet is checked (e.g., by operation of the local control processor 217). If the stream number matches its local number, the FC-DMX 201 of the ASMI 111 then writes the data to the local buffer 211 so that the data can then be displayed/sounded using the local sink device. Otherwise (stream number does not match local number), the FC-DMX 201 writes the data into its relay buffer 203 and relays that data to its downstream port in the same way as the ASMI 107 does (by way of FC-MUX 205).

Just as with the example configuration shown in FIG. 3A, this example daisy chain configuration employs external video circuitry. However, it will be appreciated in light of this disclosure that each of the ASMIs 107 can be integrated into a corresponding source device and each ASMI 111 can be integrated into a corresponding sink device. In general, any combination of source and sink circuitry can be used, whether external to or integrated with ASMI 107 or 111 circuitry. Likewise, any type of multi-component communication system that can be remote controlled by a user can benefit from the techniques described herein, and the present invention is not intended to be limited to multimedia systems.

The transmitted multimedia data (e.g., uncompressed video/audio or any other data communicated by a remote controlled multi-component system) will be associated with a bit rate (e.g., constant bit rate associated with uncompressed multimedia, or variable bit rate data). In any such cases, assume the available bandwidth for the ASMI link 100 and architecture is greater than or equal to the desired highest multimedia data rate to which the system will employ.

Media Center Configuration

FIG. 3C is a block diagram of a remote controlled multimedia data communication system configured with a media center, in accordance with an embodiment of the present invention. In this configuration, a media center 305 is provided that has one or more source ports and one or more sink ports, each configured with an ASMI as discussed with reference to FIGS. 2Aa and 2B, respectively. A control processor 203 can be used as the local processor in the media center 305. Each port (or a sub-set of available ports) interfaces with a source device 101 (ASMI 107) or sink device 109 (ASMI 111) in the same way as that in point-to-point topologies (as described with reference to FIG. 3a). There are N source devices 101 and M sink devices 109. Once again, note that M can be equal to N, but need not be.

The source ports of the media center 305 receive multimedia data from a corresponding source device 101 via a forward channel of an ASMI link 100. The ASMI 111 for that port of the media center 310 effectively operates as a forwarding state machine, by routing the received data to the proper sink port. Likewise, the sink ports of the media center 305 receive control data from a corresponding sink device 109 via a backward channel of an ASMI link 100. As will be appreciated in light of this disclosure, the control data may include a representation of IR remote control data captured at the sink device 109. The ASMI 107 for that port of the media center 310 effectively operates as a forwarding state machine, by routing the received control data to the proper source port. In one particular embodiment, each ASMI 111 and ASMI 107 operates under the control of one or more control processors (e.g., processors 213 and 217, generally referred to a “control processor” for this example embodiment) of the media center 305. As discussed herein, the control processor can evaluate address information and/or stream information included in received data packets to effect proper routing of data to its intended destination.

Data Format

In one example embodiment, the multimedia and control data in the ASMI link 100 is transmitted in packets. Each packet covers a fixed number of video pixel clocks. The packet rate on the serial interface is: Pixel clock rate/Packet size (in pixels). Based on this fixed packet size scheme, the sink-side can readily regenerate all the multimedia data and control signals.

Serial Clock Interface

The clock rate for the high speed forward channel of the ASMI link 100 is normally independent of the video clock rate. There may be more than one video/audio source, each with different clocks. Even for one video stream, the video clock can still be different for different video modes (e.g., 480p, 720p, 1080i, etc). In one particular embodiment, the high speed forward channel of the ASMI link 100 runs at a constant clock. The source device (or first source device in the daisy-chain configuration) generates this clock. All downstream devices recover this clock and use it for ASMI operation, including traffic receiving and relaying. In one embodiment, the control processor 217 (or a dedicated module included in ASMI circuit 111) is programmed or otherwise configured to implement known clock recovery techniques.

Multiple Streams

As previously discussed, a multimedia system can be designed to support multiple video/audio streams, in accordance with an embodiment of the present invention. This is useful, for example, for multi-source and/or multi-sink configurations, and for picture in picture applications. In one particular embodiment, there is an 8 bit stream number in the header of each multimedia (e.g., video/audio) data packet to indicate to which multimedia stream this packet belongs. Based on a user's stream selection, the control processor 217 programs a target stream number in the ASMI 111 of each sink device. In addition, each ASMI 107 will transmit all multimedia data from its source device with its corresponding stream number. The downstream sink device will compare the received stream number with its programmed stream number. If the two match, the stream is delivered to the local video circuit (e.g., video/audio processing section 113, such as that in a digital TV) for display/sounding. Otherwise, the packet is relayed to the next down stream port for like processing, until it is received at its intended destination.

Time Stamp Scheme

Videos are displayed in pixels, lines, and frames. Uncompressed video/audio data must be exactly synchronized with timing control signals like HSYNC (Horizontal Synchronization) and VSYNC (Vertical synchronization). In an HDMI/DVI system, there are also CTL control signals to synchronize HDCP and digital audio application. These timing control signals change their state at a specific pixel clock. The status of the signals and the time they are changing are carried over the high speed ASMI link 100 for the sink device to recreate the original video/audio.

In one particular embodiment of the present invention, each of the source devices includes or is otherwise operatively coupled to a circuit configured to record all the control signal changes (e.g., such as a dedicated circuit, control processor 213, or a microcontroller with I/O ports for receiving control signals and port routines to log signal changes). After each signal change, the new control signal values and the relative time at which the change takes place are recorded. These recorded timing data are generally referred to as time stamps. In one such case, all the time stamps are relative to the first pixel time of the packet (or some other consistent time stamp point). In addition, all the time stamps and timing control signal values are transmitted to the sink device together with the multimedia data.

At the sink-side, the video regeneration circuit (e.g., video/audio processing section 113, such as that in a digital TV) starts pixel counting from the first pixel for each packet data. When the count reaches each time stamp, the control signals are generated according to the value in the packet. In this way, all the control timing signals are regenerated at exactly the same time as they are recorded at the source-side. Note that the number of time stamps per packet time is not constant. Thus, a counter can be used to count the number of time stamps for each packet. In one such embodiment, this counter is transmitted from the source device ASMI 107 to the sink device ASMI 111, together with all the time stamps.

Blank Suppression Scheme

Typical video data includes active video pixels and about 15%-20% blank pixels. These blank pixels do not carry useful information and consume valuable bandwidth if being carried over a constrained link. As described in U.S. patent application Ser. No. 10/864,755, these blank pixels can be suppressed to save serial link bandwidth. In such an embodiment, the ASMI link will transmit active pixel data only. Application Ser. No. 10/864,755, filed on Jun. 8, 2004, and titled “Scheme For Transmitting Video and Audio Data of Variable Formats Over a Serial Link of a Fixed Data Rate,” is herein incorporated in its entirety by reference. In one such embodiment, the user can select to enable/disable blank pixel suppression for their particular multimedia communication system.

Forward Channel Data Format

In one embodiment of the present invention, the forward channel data transmitted on the ASMI link 100 is in the form of packets. One packet carries the active video data for the pre-specified number of video clocks. All fields in this example format are in the byte boundary, except the number of audio words header field and the number of audio channels header field, which can be combined into one byte. This facilitates transmitting the data using a standard serialize/deserialize (SerDes) interface and with a standard 8B/10B encoding scheme.

Each forward channel packet has the following format shown in Table 1, in accordance with one particular embodiment:

TABLE 1

| Field | | Number of Bytes |
|---|---|---|
| Headers | Packet Sequence Number | 1 |
| | Video Stream Number | 1 |
| | Number of Audio Words | ½ |
| | Number of Audio channels | ½ |
| | Video Mode | 1 |
| | Number of Active Video Words | 2 |
| | Number of Video Time Stamps | 1 |
| Control | Upstream Device Address | 1 |
| Words | Control Data | 12 |
| Time Stamps | Time Stamps 1 | 3 |
| | Time Stamps 2 | 3 |
| | Time Stamps n | 3 |
| Audio | Up to Four Channel of Audio Data | Variable |
| Video | Active Video Pixel Data | Variable |

The Packet Sequence Number is used for each device to synchronize with each other. It is incremented by one for each packet transmitted at the source. The number is wrapped back to zero when its maximum value is reached. Each downstream device should see a constantly incrementing number for this field if no packet is lost.

Video Stream Number is used for multi-video stream modes. It indicates to which video stream this packet belongs. Each device is programmed with a local steam number by the local control processor 213/217. The default value of this field is the same as the device address. The source device will use this number to transmit its multimedia data streams. The sink device will compare this field with its locally programmed number.

Number of Audio Words indicates the number of audio words transmitted in this packet. Since the audio circuit and video circuit may not share the same clock, the number of audio words generated during one video packet time is not constant. Source devices set this field and the sink devices use this field to demultiplex the correct number of audio words from the stream.

Number of Audio Channels indicates the number of audio channels transmitted in this packet. Data for each audio channel is transmitted sequentially until all the channels are transmitted.

Video Mode indicates the video mode being transmitted by this packet (e.g., 480p, 720p, 1080i, etc).

Number of Active Video Words indicates the number of active video words transmitted by this packet. Since only the active video data is being transmitted (in one particular embodiment), the number of active video data determines the packet size. The difference between Number of Video Words and Number of Active Video Words is the number of video clocks in the blank period.

As described previously, the Upstream Device Address field specifies the address of the upstream device and can be used for automatic address learning and multi video stream application.

Control Word is used to carry general purpose control data, including remote control data. Other control data can be, for example, HDCP related control information, home entertainment control information, Internet related information, and other such control information, as needed. Control words are used to exchange data among the control processors 213/217 in each device. In the forward channel of the ASMI link 100, and according to one particular embodiment of the present invention, a control word has the following format shown in Table 2:

TABLE 2

| Bytes | Content |
|---|---|
| 1 | Source Address |
| 2 | Destination Address |
| 3 | Header |
| 4 | Data Byte 1 (payload) |
| 5 | Data Byte 2 (payload) |
| 6 | Data Byte 3 (payload) |
| 7 | Data Byte 4 (payload) |
| 8 | Data Byte 5 (payload) |
| 9 | Data Byte 6 (payload) |
| 10 | Data Byte 7 (payload) |
| 11 | Data Byte 8 (payload) |
| 12 | CRC |

In one particular embodiment, the control processor 213/217 in each source or sink device performs segmentation and re-assembly functions and transmits data by this eight byte payload field. Either in point-to-point or daisy-chain configuration, the whole received control word is passed to the local control processor 213/217 for interrogation. In the same way, the local control processor 213/217 will generate all the control data traffic for the downstream device.

Audio Word has variable length and carries all the audio data. The length of this field is determined by the number of audio channels and the number of audio words fields. At the beginning of the audio word field, a four bit audio mode is first transmitted.

1: I2S

2: SPDIF

Others: Reserved for future expansion

The audio clock count field is used for the sink device's audio PLL to regenerate the original audio clock. This field indicates the number of audio clocks counted during the past packet time. In one particular embodiment of the present invention, the audio words are transmitted in the following order shown in Table 3:

TABLE 3
Audio Mode: 4 bit
Audio Clock Count: 12 bit
Audio Word 1: Channel 1
Audio Word 1: Channel 2
Audio Word 1: Channel 3
Audio Word 1: Channel n
Audio Word 2: Channel 1
Audio Word 2: Channel 2
Audio Word 2: Channel 3
Audio Word 2: Channel n
Audio Word m: Channel 1
Audio Word m: Channel 2
Audio Word m: Channel 3
Audio Word m: Channel n

Video Word has variable length and carries all the video data. The length of this field is determined by the number of active video words. Although the number of video pixel clocks during one packet time is constant, the number of active pixels is variable since there is blank pixel time. Note that the ASMI does not interpret or alter the video data content. It simply passes the data in the same order from source to sink devices. The video word field sequentially carries all the video data from the source device to the sink device. For a typical 24 bit video (standard HDMI/DVI interface and most video devices today), every pixel of video is carried by three bytes of high speed serial data.

For higher resolution (e.g., 30 bit) video, the number of bits for each video pixel may not be multiples of bytes. The video word field still sequentially carries all the video data from the source device to the sink device. The following scheme can be used, in accordance with one embodiment of the present invention for 30 bit video transmission: Each pixel of video shall be carried by four bytes of high speed serial data. Although this transmission scheme can cause the waste of 2/32=6% of bandwidth, it simplifies the data alignment and circuit design. Thus, a trade-off between wasted bandwidth and simplified alignment/circuit design can be considered when implementing a given application.

Backward Channel Data Format

The data format for the backward channel will now be described, in accordance with one embodiment of the present invention. In one particular embodiment of the present invention, the backward channel data has a similar format as the control data in the forward channel.

In one such case, the backward channel packet has a Preamble field and a Start Frame Delimiter (SFD), as is typical in communication networks. A Packet Size field can also be provided, so as to enable a variable packet size, if so desired. In one particular implementation, the source address and destination address have the same meaning as that of the forward channel control data. The control data can also have variable size (up to 256 bytes in this example). As will be apparent in light of this disclosure, the control data can include a representation of the samples of the modulated IR remote control data 254 captured at a device included in the system. In one particular embodiment, a CRC field having a two byte length is also provided. An example backward channel packet is shown in Table 4:

TABLE 4

| Field | | Number of Bytes |
|---|---|---|
| Preamble | | 2 |
| SFD | | 1 |
| Header | Packet Size | 1 |
| | Packet Type | 1 |
| | Source Address | 1 |
| | Destination Address | 1 |

| | |
|---|---|
| Control Data | Up to 256 |
| CRC | 2 |

In one particular embodiment of the present invention, each sink ASMI has a state machine for demultiplexing (e.g., FC-DMX 201 and BC-DMX 209) incoming data, and a state machine for multiplexing (e.g., FC-MUX 205 and BC-MUX 207) outgoing data. In one such embodiment, the demultiplexing state machine receives data from the upstream ASMI and separates the data into three data streams (video, audio, and control). The multimedia data (video and audio) with a video stream number that matches or otherwise corresponds to the sink device is stored in the local buffer 211 for display/sounding. The multimedia data with a non-matching video address is stored in relay buffer 203 for relaying to the downstream port. The control data is transferred to the local control processor 213/217, as previously explained. All these separations can be performed by the demultiplexing state machine based on the predefined packet format discussed herein. The multiplexing state machine of each sink ASMI receives remote control data (e.g., captured by IR detector 219 and processed by control processor 217) from the user's remote control, and multiplexes that control data onto the backward channel and/or forward channel for transmission via the ASMI link 100.

Each source ASMI has a state machine for demultiplexing (e.g., FC-DMX 201 and BC-DMX 209) incoming control data (including remote control data), and a state machine for multiplexing (e.g., FC-MUX 205 and BC-MUX 207) outgoing data. In one such embodiment, the demultiplexing state machine receives remote control data from the downstream ASMI, and regenerates the IR remote control signal (e.g., with processor 213 and IR emitter 215). The source multiplexing state machine receives multimedia data (video and audio) from the local video/audio circuit (e.g., DVD player etc.) via the local buffer 211, and takes relayed upstream multimedia data from the relay buffer 203 if there is any, as well as the control data from the local control processor 213. The multiplexing state machine then multiplexes all the data and transmits that data to the downstream ASMI via the ASMI link 100.

Multiplexing State Machine

The following pseudo code illustrates the multiplexing state machine, in accordance with one embodiment of the present invention:

```
State Idle:
    If (Relay_Buffer Non empty)
        Set Flag: Relay_up_stream_port
        Transmit Sequence Number
        Increment Sequence Number
        Go to State Transmit_Header
    Else if (Local Video data Ready)
        Set Flag: Transmit_Local_Video
        Transmit Sequence Number
        Increment Sequence Number
        Go to State Transmit_Header
    Else
        Go to State Idle
State Transmit_Header:
    If (Relay_up_stream_port)
        Relay header from Relay_Buffer to downstream port
        Go to State Transmit_Control_Data
    Else if (Transmit_Local_Video)
        Transmit number of audio word and number of audio channel
        Transmit video stream number
        Transmit video mode
        Transmit number of active video word
        Transmit number of video time stamps
        Go to State Transmit_Control_Data
State Transmit_Control_Data:
    Transmit upstream device address
    Transmit General Purpose Control Data from local processor
    Go to State Transmit_Time_Stamps
State Transmit_Time_Stamps:
    If (Relay_up_stream_port)
        Relay all video time stamps from the Relay_Buffer
        Go to State Transmit_Audio_Data
    Else if (Transmit_Local_Video)
        Transmit all video time stamps (specified by number of time
            stamps) from local video device
        Go to State Transmit_Audio_Data
State Transmit_Audio_Data:
    If (Relay_up_stream_port)
        Relay all Audio Data from the Relay_Buffer
        Go to State Transmit_Video_Data
    Else if (Transmit_Local_Video)
        Transmit audio data (specified by number of audio word)
            from local device
        Go to State Transmit_Video_Data
State Transmit_Video_Data:
    If (Relay_up_stream_port)
        Relay all Video Data from the upstream port
        Go to State Idle
    Else if (Transmit_Local_Video)
        Transmit all video data (specified by number of active Video
            Data) from local video device
        Go to State Idle
```

Demultiplexing State Machine

The following pseudo code illustrates the demultiplexing state machine, in accordance with one embodiment of the present invention:

```
State Idle:
    If (Upstream_ASMI_Packet_Detected)
        Go to State Receive_Sequence_Number
    Else
        Go to State Idle
State Receive_Sequence Number
        Record packet sequence number
        Go to State Receive_Stream_Number
State Receiver_Stream_Number:
    If (Stream_number matches local sink device address)
        Set Local stream flag
        Go to State Receive_Header
    Else
        Clear Local stream flag
        Go to State Receive_Header
State Receive_Header:
    If (Local Stream)
        Store header to local_buffer
        Go to State Receive_control_word
    Else
        Store header to relay_buffer
        Go to State Receive_control_word
State Receive_control_word:
    Transfer general purpose control word to local processor
    Go to State Receiver_Audio_Data
State Receive_Audio_Data:
    If (Local Stream)
        Transmit audio data (specified by number of audio word)
        to local device
        Go to State Receive_Video_Data
    Else if (Transmit_Local_Video)
        Relay all audio Data (specified by number of audio word) to
        relay_buffer
        Go to State Receive_Video_Data
State Receive_Video_Data:
    If (Local Stream)
        Transmit video (specified by number of active Video Data) to
        local_buffer and local video device
        Go to State Idle
    Else if (Transmit_Local_Video)
        Relay all Video Data from the upstream port to the relay_buffer
        Go to State Idle
```

HDCP over ASMI

HDCP (High Definition Content Protection) is a protocol developed for the HDMI and DVI interface to carry protected video/audio signals. One embodiment of the present invention can be used to implement the HDCP protocol over the ASMI link 100. The employed communication schemes are based on HDCP specification. All the key vectors and key exchange schemes are the same as HDCP. The generation and application of the encryption polynomials are the same as that in the standard HDCP protocol.

Data transmitted over the forward channel serial link are encrypted. In the source device, the data is encrypted at the parallel bus before the SerDes. On the sink-side, the data is decrypted at the parallel bus of the SerDes output. In a typical HDMI or DVI based HDCP system, the source device periodically (about every two seconds) reads link verification value Ri′ from the sink device. The link verification fails if the Ri′ value is wrong.

If the data is carried over an optical wireless link for the forward channel, the backward channel can be implemented with an RF wireless link (e.g., 802.11 or other suitable RF wireless link technology). A typical wireless link has more noise and more transmission errors. However, there are techniques that can be used to improve the reliability of the HDCP link verification in the noise environment. One technique is more retransmission. In particular, the link verification value Ri′ can be sent from sink to source every millisecond (or so), continuously. A few corrupted values will be detected and not cause any problem. Another technique is where the source-side can compare the received value with its newly generated value and previous value. Either match indicates a valid HDCP verification. With this technique, any delay of the new Ri′ caused by network latency or re-try latency will not cause HDCP verification failure.

For the sink-side to decrypt the data correctly, the sink and source device must be in synchronization for the packets and the data words. Packet data format for the ASMI as described herein provides an easy way for this synchronization. In particular, each packet header contains a packet sequence number. Sink and source devices can use this sequence number to get synchronized with each other. All the key exchange, key update, polynomial generation, data encryption and decryption are all synchronized with this sequence number.

Remote Control Signal Processing

FIG. 4A is a block diagram of a multimedia data communication system configured for integrated remote control signaling, in accordance with an embodiment of the present invention. As can be seen, the link 100 between the source device and sink device is implemented with an ASMI scheme as described herein. There is no physical copper wire between the two ASMI 107 and 111. In this embodiment, the ASMI device 107 and/or ASMI device 111 (along with their respective remote control processes 107a and 111a) are integrated into their corresponding video source and sink devices. The ASMI 107 and ASMI 111 are communicatively coupled by the optical fiber ASMI link 100 (e.g., a high speed forward channel and lower speed backward channel). In other embodiments, the ASMI 107 can exist independently of (and be connected to) the video source device, for example, via a standard HDMI/DVI interface. Likewise, the ASMI 111 device can exist independently of (and be connected to) the video sink device.

The forward channel of this example embodiment provides high bandwidth for video, audio and/or other types of user data, such as IR data, to the video sink-side (e.g., DTV), while the backward channel with relatively low data bandwidth is utilized to carry user data for link integrity checking and other purposes (including transmission of remote control data) to the video source-side (e.g., DVD player). IR control signal data from the user's remote control in modulated form is captured and sampled by the remote control process 111a and converted into electrical signals that are multiplexed on the backward channel by operation of ASMI 111. Those remote control signals are communicated over the ASMI link 100 and received at the video source device ASMI 107, which demultiplexes the remote control signals and provides them to the remote control process 107a. The remote control process 107a can then convert those control signals into a form usable by the video source device to activate the requested control on the source device. For instance, the remote control process 107a can convert the control signals back into IR form to illuminate an IR sensor of the video source device control circuit. Other embodiments may provide the control signals in another form (e.g., electrical signal) suitable to activate the video source device control circuit.

In more detail, and in accordance with one embodiment of the present invention, the output 254 of the IR detector 219 replicates the shape of the input IR signal 250. When the IR detector 219 detects IR control data (e.g., after a user engages the remote control of the video source device to advance through chapters of a DVD or other such source device control), the IR detector 219 outputs a stream sequence of modulated, high and low pulses 254. The stream starts with a period of low signal, and ends with a period of high signal. As explained above, this IR output 254 is sampled by the control processor 217 and represented as digital “0” and “1” stream levels, where “0” is for the low part of the IR signal 254, and “1” for the high part of the IR signal 254.

Two factors are considered when the sampling period is selected: signal distortion and the amount of data stream to represent the detected IR control data signal. In general, the shorter the sampling period, the lower the IR signal distortion level when it is restored at the video source-side. However, the shorter the sampling period, the more data that is needed to characterize the signal.

In one particular case, eight samples are grouped as a byte. In such an embodiment, the ASMI 111 is configured to place a fixed length of bytes (e.g., 128 bytes) into a FIFO (First-In First-Out) buffer (included in the control processor 217 or in a dedicated buffer, not shown). For example, with a 4 Mbps sampling rate, 128 bytes of data could hold 256 microseconds of IR signal (128×8 bits/4 Mbps=256 microseconds). The FIFO buffer contents are processed into a packet by operation of the control processor 217. The packet is then multiplexed onto the backward channel of the ASMI link 100 by operation of BC-MUX 207 for transmission over the ASMI link 100 to the ASMI 107 of the video source device.

After the ASMI 107 of the video source-side receives the IR control data packet, it sends an acknowledgement (ACK) packet to the ASMI 111 by the forward channel to inform the ASMI 111 of the IR control data packet reception. If the received IR control data packet is corrupted on the back channel transmission, the ASMI 107 will not send the ACK packet to the ASMI 111 of the video sink-side. If the ASMI 111 does not receive the ACK packet in a given period of time (e.g., 50 microseconds), the ASMI 111 will resend 425 the IR control data packet, until it receives an ACK packet or until a timeout occurs. The timeout mechanism is used to prevent resending of IR data packet in perpetuity (e.g., in the event of a disabled link 100 or other communication failure). If a 4 Mbps sampling rate is used for the IR signal, then the backward channel bandwidth is at least 16 Mbps for this retransmission scheme 425. After timeout, the ASMI 111 discards the IR control data, and prepares to send the next IR control data packet if any IR packet is pending to be sent.

The remote control process 107a of ASMI 107 can regenerate the received remote control signal data in various ways. In one particular embodiment, the direct output of digital signal is used (i.e., no conversion to IR). Such a direct digital output can readily interface with other digital remote control circuitry included in the video source device. Alternatively, the digital remote control data signal (including the modulation information) can be converted to a modulated IR signal. For instance, the direct digital output can be used to drive an IR LED to emit a corresponding IR signal. This type of IR signal can also be readily received by a video source device, which typically has built-in IR detector circuitry.

Methodology

FIGS. 4B and 4C illustrate an integrated remote control signaling scheme configured in accordance with an embodiment of the present invention. As can be seen, this example method includes a number of steps carried out at the sink-side and other steps carried out at the source-side. Numerous variations will be apparent, and the present invention is not intended to be limited to any one such configuration. Moreover, the example embodiment is not intended to implicate any rigid ordering of steps or temporal limitations. Rather, the steps can be processed in any logical order an in a synchronous or asynchronous manner. The method can be carried out, for example, by the systems and modules discussed with reference to FIGS. 1, 2A, 2B, 2D, 3A, 3B, 3C, and 4A. The various functionalities can be implemented in software, hardware, or a combination thereof, as will be apparent in light of this disclosure.

The method begins with sampling 405 the modulated IR remote control signal in modulated form (without demodulation), and grouping 407 the IR remote control signal samples into a data packet (one or more data packets can be used, depending on the packet format used). The method proceeds with sending 409 the remote control data packet to the source device via a serial communication link. As previously explained, one embodiment implements the communication link with a single optical fiber 100 having a forward channel and a backward channel. The remote control data packet can be communicated using the backward channel of the serial communication link. In other embodiments, the remote control data packet is communicated wirelessly using an optical beam (e.g., IR transceivers configured with grating assisted waveguides). Other embodiments can use an RF link (e.g., 802.11) to transmit the remote control data packet to the source-side.

At the source-side, the method includes receiving 411 the remote control data packet at the source-side, and then determining 413 if the received remote control data packet is corrupted. If not, then the method continues with sending 415 an ACK packet to the sink device, and regenerating 417 the remote control signal. Note that the IR signal is in modulated form, including the carrier frequency. Thus, this regeneration may include providing an electrical output signal (which may or may not have the same format as the received signal), or an IR signal generated by driving an IR light-emitting diode with the received remote control signal. The method continues with providing 419 the regenerated remote control signal to the source device, thereby controlling that device based on the user's remote control action provided at the sink device. If the received packet is corrupted, the method does not send 421 an acknowledgement (ACK) packet to the sink device.

At the sink-side, the method includes determining 423 whether an ACK packet has been received within the pre-set time limit (e.g., 50 microseconds). If not, the method continues with re-sending 425 the data packet to the source device, and determining 427 if a timeout has occurred. In one such embodiment, a timeout can be signaled if the remote control data packet has been re-sent more than three times, although numerous other timeout schemes can be used. If a timeout has occurred, then the method continues with discarding 429 the remote control data packet (note that this situation will rarely occur). If no timeout has occurred, then the method continues by repeating steps 423 and 425 until either an ACK packet is timely received or a timeout occurs. If an ACK packet is received in step 423 or a timeout has occurred 427 and the packet is discarded in step 429, the method will go back to step 405 and repeat steps 405 through 429 as needed, notwithstanding timeouts and other such desired flow control mechanisms.

FIG. 4D shows how the ASMI-enabled source and sink devices handle the case when the forward and/or backward channel is impaired, in accordance with an embodiment of the present invention. As can be seen in this example exchange, the control processor 217 in the sink device (e.g., DTV) after power up starts sampling 454 a fixed length (e.g. 128 bytes) of the modulated IR remote control signal (without de-modulation), and then sends 456 (via the backward channel of the ASMI link) a packet including the sampled, modulated remote control signal data to the source device (e.g., DVD player). The source device then sends 458 an ACK packet (via the forward channel of the ASMI link), and provides 458 the remote control signal data to the source device control circuitry. However, the forward channel is down, and the ACK packet is therefore not received by the sink device. Thus, after a pre-set period of time, the sink device re-sends 460 (via the backward channel) the packet including the sampled, modulated remote control signal data to the source device. The source device then sends 462 an ACK packet (via the forward channel), which this time is received by the sink device. Note that the source device recognizes the remote control signal data packet was previously received and processed, and does not duplicate that remote control data a second time (rather, only an ACK is sent). In response to the ACK, the sink device sends 464 the next packet including remote control signal data to the source device. However, the backward channel is now down, and the source device therefore never receives the packet. As a result, the source device does nothing 466. Thus, after a pre-set period of time, the sink device re-sends 468 (via the backward channel) that next packet to the source device. The source device then sends 470 an ACK packet (via the forward channel), and provides the remote control signal data to the source device control circuitry. This process of sending packets including remote control data and acknowledgment can be repeated any number of time to communicate all remote control data provided by the user.

Remote Control Signal Format

The scheme described herein to sample an IR remote control signal at one device and send it to another device via an ASMI is a universal and integrated IR repeating solution. As is known, IR remote control signals have different standards among manufactures. For a specific manufacture, the format of IR remote control signals is typically consistent due to the compatibility consideration of the legacy product. In this case, a method can be employed to recognize the IR remote control signal from a number of remote control manufactures, and to abstract that signal to a few bytes of data that describe the IR remote control signal. To send these fewer bytes of data requires lower bandwidth.

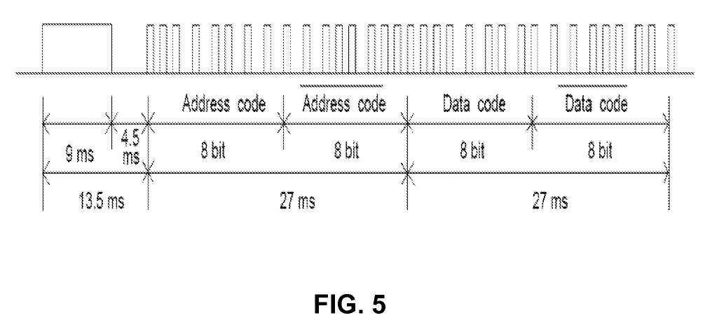

FIG. 5 illustrates how an example IR remote control signal (based on NEC framing for a key code press) is characterized as the digital signal data, in accordance with an embodiment of the present invention. As is known and shown in FIG. 5, the start sequence or lead code of the NEC data format is a 9 milliseconds (ms) carrier of 38 KHz square wave, followed by a 4.5 ms idle period. The IR detector 219 would detect this modulated IR signal as 9 ms low and 4.5 ms high, identical to the shape of the modulated IR signal. After this lead code sequence, the NEC data format continues with a first byte (8-bits) of address data and the complement of the first byte address data for 27 ms, and with a second byte (8-bits) of command data and the complement of the second byte command data for another 27 ms. The address code identifies the device to be controlled, such as TV and DVD. The data code is the command, such as volume up/down, power on/off, fast forward, rewind, etc.

Generally stated, the ASMI scheme described herein need not be aware of the meaning of this vendor-specific data, because the modulated IR signal is detected as is in modulated form and is regenerated as is in modulated form. There is no need for the source device to understand the meanings of the particular codes used in the IR signal to regenerate the IR signal, since the source device received the IR signal over the ASMI link in modulated form itself.

By utilizing two-way communication as described by one embodiment herein, an IR remote control signal can be securely duplicated on the source-side when the user provides the remote control signal to the sink-side. The IR repeating is “universal” because it does not require knowledge of the modulation frequency of the IR signal. The IR repeating scheme in this disclosure will work with any modulation frequency, because the modulation frequency is embedded in the sampled IR control signal itself that is transmitted from the sink device to the source device over the ASMI link. The integrated solution makes controlling a video source device easy for a user, in that the user can intuitively point the IR remote control at the video sink device (e.g., TV) to control a source device that is not in the consumer's forward field of view. No separate cabling (other than the optical fiber) for carrying the remote control signals is needed. Rather, the remote control signaling data is carried, for example, in the same optical fiber as the payload data (e.g., video and/or audio), or via a wireless transmission (e.g., RF or optical). In either such cases, a forward channel can simultaneously carry payload data from the source device to the sink device.

The foregoing description of the embodiments of the invention has been presented for the purposes of illustration and description. It is not intended to be exhaustive or to limit the invention to the precise form disclosed. Many modifications and variations are possible in light of this disclosure. For example, multimedia typically includes video and audio data. However, embodiments of the present invention can operate with any type of data, such as presentation slides, study materials, graphics (e.g., digital art or slide shows, with or without audio), audio only (e.g., music or audio books), and video (e.g., movies with or without audio), or other types of data that can be presented in a system having one or more sink devices and one or more source devices that operate under remote control. It is intended that the scope of the invention be limited not by this detailed description, but rather by the claims appended hereto.

What is claimed is:

1. A method for communicating remote control information in a system including a source device and a sink device that are communicatively coupled by a serial communication link that includes a forward channel and a backward channel, comprising:
at the sink device, detecting modulated infrared (IR) remote control signal data for the source device;
sampling the modulated IR remote control signal data to form an electrical signal; and
sending the electrical signal to the source device via the backward channel, wherein the forward channel can simultaneously carry payload data from the source device to the sink device;

2. The method of claim 1, wherein the backward channel is implemented using a single optical fiber and the forward channel is implemented using the same single optical fiber as the backward channel.

3. The method of claim 1, wherein the electrical signal includes modulation frequency information of the IR remote control signal.

4. The method of claim 1, wherein the IR remote control signal is sampled in modulated form without de-modulation.

5. The method of claim 1, wherein:
sampling the IR remote control signal data to form an electrical signal includes grouping samples of the modulated IR remote control signal data into a data packet; and
sending the electrical signal to the source device includes sending the data packet to the source device.

6. The method of claim 1, further comprising:
at the source device, receiving the electrical signal; and
controlling the source device in accordance with the IR remote control signal data represented by the electrical signal.

7. The method of claim 6, wherein receiving the electrical signal includes determining if the electrical signal is corrupted, and in response to the electrical signal not being corrupted, the method further comprises sending an acknowledgment to the sink device via the forward channel.

8. The method of claim 6, wherein controlling the source device further comprises regenerating the IR remote control signal data based upon the received electrical signal.

9. The method of claim 1, further comprising:
sending an acknowledgment to the sink device via the forward channel, so as to acknowledge receipt of the electrical signal at the source device;
at the sink device, determining whether an acknowledgment has been received within a pre-set time limit; and
in response to no acknowledgment being received within the pre-set time limit, re-sending the electrical signal to the source device.

10. The method of claim 9, further comprising:
determining if a timeout has occurred;
in response to the timeout, discarding the IR remote control signal data; and
in response to no timeout, repeating re-sending the electrical signal to the source device until either an acknowledgment is timely received or the timeout occurs.

11. A system for communicating remote control information between a source device and a sink device that are communicatively coupled by a serial communication link that includes a forward channel and a backward channel, the system comprising:
a sink-side infrared (IR) detector for detecting IR remote control signal data for the source device, the sink-side IR detector detecting and outputting the IR remote control signal data in modulated form;
a sink-side control processor for sampling the modulated IR remote control signal data to form an electrical signal corresponding to samples of the modulated IR remote control signal data; and
a sink-side transmitter for sending the electrical signal to the source device via the backward channel, wherein the forward channel can simultaneously carry payload data from the source device to the sink device;

12. The system of claim 11, wherein the backward channel is implemented using a single optical fiber and the forward channel is implemented using the same single optical fiber as the backward channel.

13. The system of claim 11, wherein the sink-side IR detector receives the IR remote control signal data and outputs amplified IR remote control signal data having a modulated shape replicating a modulated shape of the received IR remote control signal data.

14. The system of claim 11, wherein the sink-side IR detector detects the modulated IR remote control signal data without de-modulation.

15. The system of claim 11, wherein the electrical signal includes modulation frequency information of the IR remote control signal data.

16. The system of claim 11, further comprising:
a source-side receiver for receiving the electrical signal; and
a source-side remote control process for controlling the source device in accordance with the modulated IR remote control signal data represented by the electrical signal.

17. The system of claim 11, further comprising:
a source-side transmitter for sending an acknowledgment to the sink device via the forward channel, so as to acknowledge receipt of the electrical signal at the source device;
wherein the sink-side control processor is further configured for determining whether an acknowledgment has been received within a pre-set time limit, and in response to no acknowledgment being received within the pre-set time limit, for causing the sink-side transmitter to re-send the electrical signal.
